(19) United States
(12) Patent Application Publication
(10) Pub. No.: US 2006/0277398 A1
(43) Pub. Date: Dec. 7, 2006

(54) Method and apparatus for instruction latency tolerant execution in an out-of-order pipeline

(75) Inventors: Haitham H. Akkary, Portland, OR (US); Ravi Rajwar, Portland, OR (US); Srikanth T. Srinivasan, Portland, OR (US); Christopher B. Wilkerson, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 11/145,409

(22) Filed: Jun. 3, 2005

(51) Int. Cl. G06F 9/44

(52) U.S. Cl. 712/245

(57) ABSTRACT

A method and apparatus for setting aside a long-latency micro-operation from a reorder buffer is disclosed. In one embodiment, a long-latency micro-operation would conventionally stall a reorder buffer. Therefore a secondary buffer may be used to temporarily store that long-latency micro-operation, and other micro-operations depending from it, until that long-latency micro-operation is ready to execute. These micro-operations may then be reintroduced into the reorder buffer for execution. The use of poisoned bits may be used to ensure correct retirement of register values merged from both pre- and post-execution of the micro-operations which were set aside in the secondary buffer.

### FIELD

The present disclosure relates generally to microprocessors that permit out-of-order execution of operations, and more specifically to microprocessors that use reorder buffers to execute operations out-of-order.

### BACKGROUND

Microprocessors may utilize data structures that permit the execution of portions of software code or decoded micro-operations out of the written program order. This execution is generally referred to simply as “out-of-order execution”. In one conventional practice, a buffer may be used to receive micro-operations from a program schedule stage of a processor pipeline. This buffer, often called a reorder buffer, may have room for entries that include the micro-operations and additionally the corresponding source and destination register values. The micro-operations of each entry are free to execute whenever their source registers are ready. They will then temporarily store their destination register values locally within the reorder buffer. Only the presently-oldest entry in the reorder buffer, called the “head” of the reorder buffer, is permitted to update state and retire. In this manner, the micro-operations in the reorder buffer may execute out of program order but still retire in program order.

One performance issue with the use of a reorder buffer is the occurrence of long-latency micro-operations. Examples of these long-latency micro-operations may be when a load misses in a cache, when a translation look-aside buffer misses, and several other similar occurrences. It is not even apparent ahead of time that such micro-operations will require a long latency, as sometimes the same load may be a hit in a cache or a miss in that cache. When such a long-latency micro-operation reaches the head of the reorder buffer, no other micro-operations may retire. For this reason, the reorder buffer experiences a stall condition.

In order to ameliorate this stall condition, conventional approaches have included making the reorder buffer very large or making the caches very large. Both techniques may require excessive allocation of circuitry on the processor die. Making the reorder buffer larger is especially resource consuming, as it is a structure with multiple access ports, and the complexity of a memory device with multiple access ports generally rises at the power of the number of access ports.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram of a processor including a slice data buffer, according to one embodiment.

FIG. 2 is a schematic diagram of logic within a processor, according to one embodiment.

FIG. 3 is a schematic diagram of logic within a processor showing a long-latency micro-operation being moved to a slice data buffer, according to one embodiment.

FIG. 4 is a schematic diagram of logic within a processor showing a dependent micro-operation being moved to a slice data buffer, according to one embodiment.

FIG. 5 is a schematic diagram of logic within a processor when a long-latency micro-operation is ready to execute, according to one embodiment.

FIG. 6 is a schematic diagram of logic within a processor showing reinsertion of a long-latency micro-operation, according to one embodiment.

FIG. 7 is a schematic diagram of logic within a processor showing merging of register file copies, according to one embodiment.

FIG. 8 is a flowchart diagram of a method for executing long-latency micro-operations, according to one embodiment of the present disclosure.

FIGS. 9A and 9B are schematic diagrams of systems including processors with slice data buffers, according to two embodiments of the present disclosure.

### DETAILED DESCRIPTION

The following description describes techniques for improved processing of long-latency micro-operations in an out-of-order processor. In the following description, numerous specific details such as logic implementations, software module allocation, bus and other interface signaling techniques, and details of operation are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation. In certain embodiments the invention is disclosed in the form of reorder buffers present in implementations of Pentium® compatible processor such as those produced by Intel® Corporation. However, the invention may be practiced in the pipelines present in other kinds of processors, such as an Itanium® Processor Family compatible processor or an X-Scale® family compatible processor.

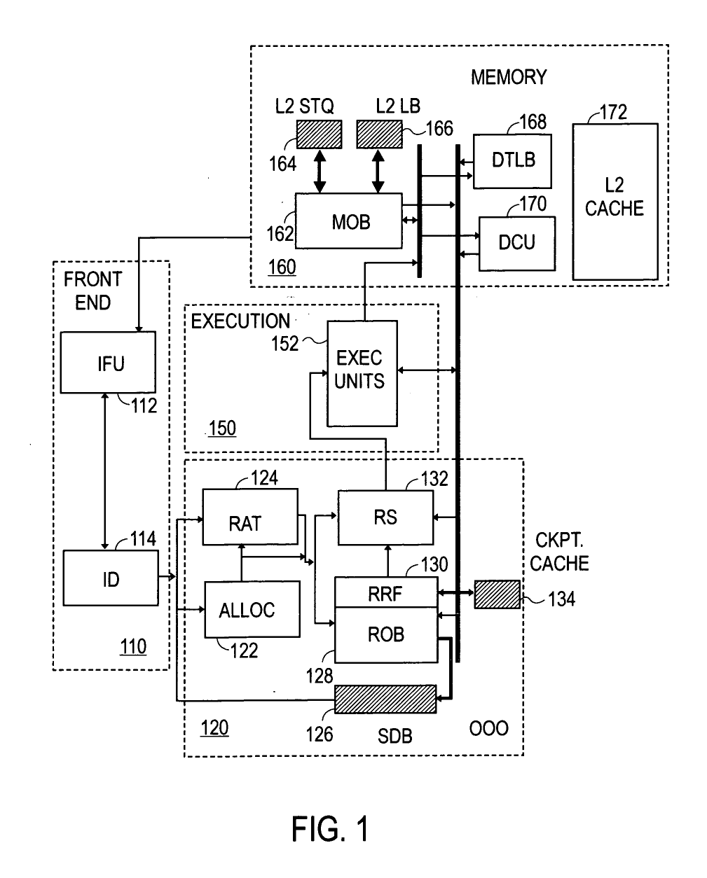

Referring now to FIG. 1, a schematic diagram of a processor including a slice data buffer is shown, according to one embodiment. Shown in this embodiment is processor 100 with major logic areas front end 110, out-of-order (OOO) stage 120, execution stage 150, and memory interface 160.

Front end 110 may include an instruction fetch unit (IFU) 112 for fetching instructions from memory interface 160, and also an instruction decoded (ID) queue 114 to store the component decoded micro-operations of the fetched instructions.

OOO stage 120 may include certain logic areas to permit the execution of the micro-operations from ID queue 114 out of program order, but permit them to retire in program order. An allocation stage (ALLOC) 122 and register alias table (RAT) 124 together may perform scheduling of the micro-operations store in ID queue 114 along with register renaming for those micro-operations. The scheduled micro-operations may be placed in a reorder buffer (ROB) 128 for execution out-of-order, but retirement in order, in conjunction with a real register file (RRF) 130. The ROB 128 places micro-operations in program order with the oldest micro-operation occupying the “head” of ROB 128. Only those micro-operations currently occupying the head of ROB 128 may be permitted to retire.

In one embodiment a “slice data buffer” (SDB) 126 may be used to augment the capacity of ROB 128. Rather than permitting a long-latency micro-operation, when it becomes the oldest micro-operation in ROB 128, from stalling the ROB 128, the long-latency micro-operation may be temporarily set aside in SDB 126. Various kinds of micro-operations may be deemed long-latency, including loads that miss in the cache. In addition to the long-latency micro-operation, other micro-operations that depend upon that long-latency micro-operation may also be placed into the SDB 126. Here the micro-operations which depend upon the long-latency micro-operation may include those whose source registers may include a destination register of the long-latency micro-operation. Such dependent micro-operations may be placed into SDB 126 when they each reach the head of ROB 128 in their turn. In one embodiment SDB 126 may be implemented as a first-in first-out (FIFO) buffer, but many other kinds of buffer could be used.

SDB 126 may be implemented as a single-port FIFO buffer, organized as blocks of micro-operations. Each block may have the same number of micro-operations as the width of the rename stage. The long-latency micro-operation and its dependent micro-operations may be written to SDB 126 at pseudo-retirement, and in program order. Since the retirement rate of these micro-operations from the ROB 128 may often be less than the retirement stage width, and since the long-latency micro-operation and its dependent micro-operations in a given cycle may not necessarily be adjacent in the ROB 128, alignment multiplexers may be used at the input of SDB 126 to pack the pseudo-retired micro-operations together in SDB 128.

Each entry in SDB 128 may have storage for the micro-operation, one completed source operand, and L1 and L2 store buffer identifiers. In other embodiments, other items may be used in each entry. Additional control bits, such as source valid bits, may also be used. In a second embodiment, the micro-operation may be stored in SDB 128 and the completed source operand may be stored in an alternate storage logic (not shown). In this second embodiment, the alternate storage logic may include pointers that may link the completed source operands with their corresponding micro-operations in SDB 128. Fused micro-operations may have two completed sources, and may occupy two entries to store both sources. When the micro-operations are reinserted after the long-latency micro-operation completes, the micro-operations may be sent in order to the RAT 124 and ALLOC 122 to perform register renaming and allocation. The completed sources may be sent to one input of a multiplexer that drives the source operand buses. For these sources, the ROB 128 and RRF 130 operand-reads may be bypassed.

The SDB 126 may be implemented as an static random-access-memory (SRAM) array and may not be latency critical. In one embodiment, a 340-entry SDB 126 may be sufficient for tolerating current miss latencies. Each entry may be approximately 24 bytes in size for a total SDB 126 size of approximately 8 K bytes.

In one embodiment, a checkpoint cache 134 may be used to store a safety copy of the contents of the RRF 130. This safety copy may be used to restore the processor state when an exception or other error condition is later determined to exist with respect to the long-latency micro-operation or one of its dependent micro-operations placed into the SDB 126.

In one embodiment, when the identified long-latency micro-operation reaches the head of ROB 128, a checkpoint of the register state at that point (architectural as well as micro-architectural) may be created by copying all registers from the RRF 130 to checkpoint cache 134. Since the copying may be a multi-cycle operation, retirement cannot proceed during this time. However, out-of-order execution may proceed normally and micro-operations may continue flowing down the pipeline as long as ROB 128 and other buffers are not full.

Once the long-latency micro-operation completes, and micro-operations from SDB 126 are re-inserted into the pipeline and start executing, a recovery event such as branch misprediction based upon a dependent micro-operation of the long-latency micro-operation, fault, or micro-assist may occur. In this case, the checkpointed state may be copied back to RRF 130 before restarting execution as part of the recovery action. The execution may then restart from the identified long-latency micro-operation. (It may be noteworthy that a branch misprediction based upon an independent micro-operation from said long-latency micro-operation may not need restore to the checkpointed state.)

The micro-operations within SDB 128 may often execute without such recovery events, and the checkpoint may be simply discarded when the micro-operations execute and retire. The instruction pointer (or micro-instruction pointer) for the restart points to the checkpoint and not the micro-operation that has caused the event. Conventional reorder buffer-based mechanisms may operate to make more likely successful handling of the event once the long-latency micro-operation retires and the processor returns to conventional reorder buffer operation.

In other embodiments, checkpoints at other points in the window after a long-latency micro-operation are possible, and may lower the overhead cost associated with execution roll-back to a checkpoint on recovery events.

In one embodiment, checkpoint cache 134 may be designed using an SRAM array. Four checkpoints may be sufficient for performance and for handling multiple outstanding misses. The overall size of checkpoint cache 134 with four checkpoints may be less than 3K bytes.

When the long-latency micro-operation stored in the SDB 126 is ready for execution, the contents of the SDB 126 may be returned to the ROB 128 for execution. In one embodiment, the contents of the SDB 126 may be sent via the ALLOC 122 to ROB 128. In other embodiments, other paths to return the contents of the SDB 126 for execution could be used. In one embodiment, some or all of the contents of the SDB 126 could be sent directly via the reservation station (RS) 132 to the execution stage 150.

Processor 100 may also include a memory stage 160. This memory stage may include a level two (L2) cache, a data translation look-aside buffer (DTLB) 170, a data cache unit (DCU) 170, and a memory order buffer (MOB) 162. The MOB 162 may store pending stores to memory. In one embodiment, a level two store queue (L2STQ) 164 may be added to track the order of stores executed later (in program order) than a long-latency micro-operation stored in SDB 126. L2STQ 164 may also forward data to subsequent loads. In one embodiment, L2STQ 164 may be a hierarchical store buffer including a level one (L1) and an L2 store buffer.

Memory stage 160 may also include an L2 load buffer (L2 LB) 166. L2LB 166 may be added to track the addresses of loads executed later (in program order) than a long-latency micro-operation stored in SDB 126. In one embodiment L2LB 166 may be a set associative array that contains addresses for completed loads retired from an L1 load buffer (not shown) within MOB 162. Entries in L2LB 166 may include a load address, a checkpoint ID, and a store buffer ID that may associate the load with the closest earlier store in program order. The L2LB 166 may perform snoops on stores found in SDB 126 for potential memory ordering violations. In case of a violation, a restart from the checkpoint may take place. The L2LB 166 may also perform snoops to external stores for memory consistency. The L2LB 166 may not have to maintain order, because an internal or external invalidation snoop hit in L2LB 166 may result in a restart from the checkpoint.

Loads from SDB 126 may be allocated new entries in the L1 load buffer when reinserted from SDB 126 into ALLOC 122. Load-store ordering (for the same address) among independent micro-operations or among micro-operations within SDB 126 may be handled in the L1 load buffer as usual. In one embodiment, a load within SDB 126 may stall until all unknown stores within the micro-operations within SDB 126 are resolved, while in another embodiment the loads may issue speculatively and the L1 load buffer may snoop stores to detect memory violations within the micro-operations within SDB 126 (as may occur in conventional load buffers).

When the micro-operations within SDB 126 are re-inserted into ROB 128, complete execution, and have their checkpoint in checkpoint cache 134 discarded, all loads associated with the checkpoint may be bulk reset in the L2LB 166. In one embodiment the L2LB 166 may be an SRAM array and may not be latency critical. Assuming 8-byte addresses and 512-entry L2LB 166, the total required buffer capacity is 4 K bytes.

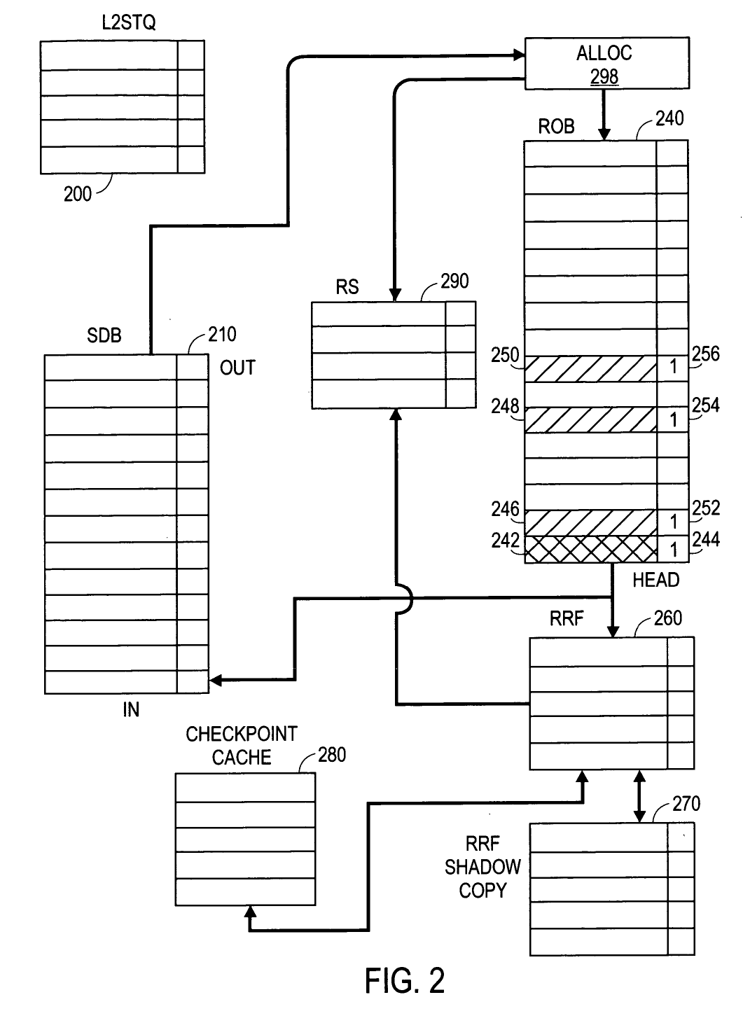

Referring now to FIG. 2, a schematic diagram of logic within a processor is shown, according to one embodiment. In one embodiment, the logic shown in FIG. 2 may include selected functional logical blocks as discussed in connection with FIG. 1 above.

In one embodiment, many of the functional logical blocks may have special identifier bits or flags to indicate status with respect to the micro-operations stored in the SDB 210. In one embodiment, these may be called “poisoned bits”. The following structures may have poison bits associated with each entry: ROB 240, RS 290, RRF 260, L2STQ 200, and an RRF shadow copy 270.

When a long-latency micro-operation is detected, the uop's ROB entry may be “poisoned”: in other words, its poison bit may be SET (e.g. to logic 1). Subsequent micro-operations, one of whose source registers may be the poisoned micro-operation's destination register also may then set their poison bits to 1 and may be considered “poisoned”.

Generally, any micro-operation that reads the result (e.g. the destination register value) of a poisoned micro-operation may itself be poisoned. The “read” may get its data from the ROB 240, RS 290, RRF 260, L2STQ 200, or RRF shadow copy 270. For this reason, in one embodiment all these structures are shown as having poisoned bits associated with each of their entries.

Poison bits may originate with loads that are known to have missed the cache, or other long-latency micro-operations. When the oldest micro-operation in ROB 240 is such a load, as soon as the memory sub-system informs the scheduler that the load has missed the cache the load may be marked as poisoned. In the FIG. 2 example, load 242 at the “head” of ROB 240 is the oldest micro-operation, and has missed in the cache. Therefore its poison bit 244 is set.

The presence of poison bit 244 may then cause a checkpoint of RRF 260 to be made and stored in checkpoint cache 280.

A scheduler (not shown) of OOO stage 120 may then determine that several other micro-operations within ROB 240 are dependent upon long-latency micro-operation 242. In the FIG. 2 example, these dependent micro-operations are micro-operations 246, 248, and 250. The scheduler may then identify these micro-operations to be poisoned, and forward this information to ROB 240. These micro-operations may then have their associated poison bits 252, 254, and 256, respectively, set.

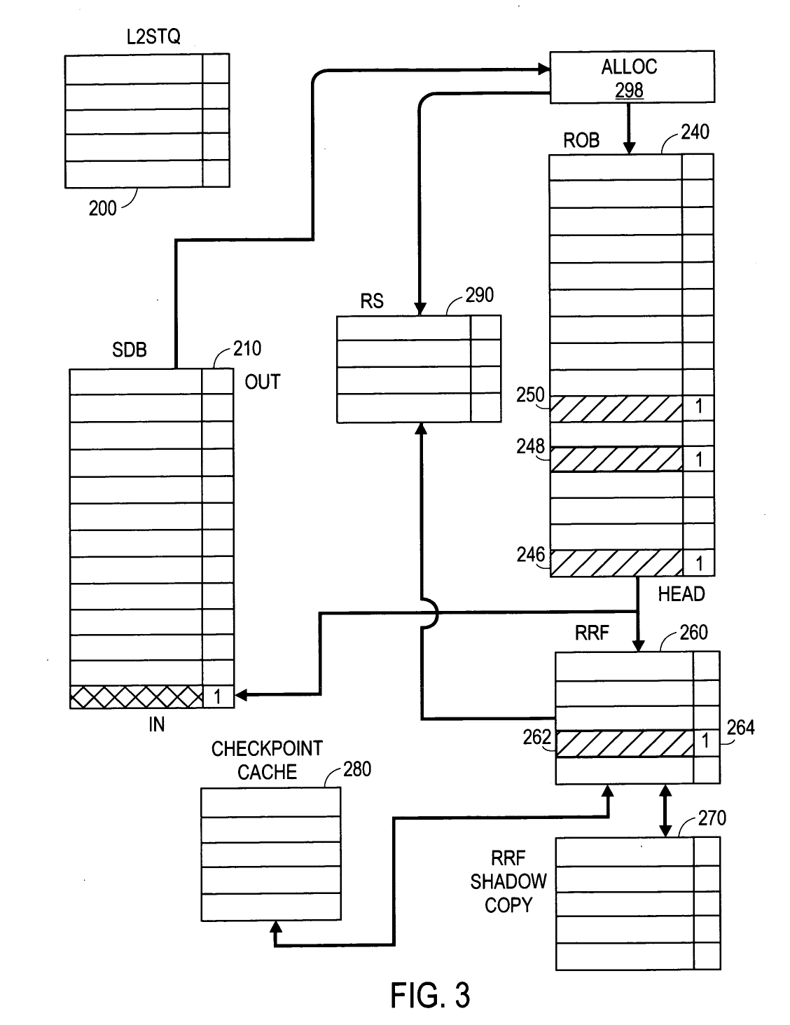

Referring now to FIG. 3, a schematic diagram of logic within a processor shows a long-latency micro-operation being moved to a slice data buffer, according to one embodiment. In one embodiment, micro-operation 242, along with one source register contents (if ready), may be moved into an entry in SDB 210. When this happens, destination register 262 of micro-operation 242 may have its poison bit 264 set. Other entries in the ROB 240 advance towards the head, including the dependent micro-operations 246, 248, and 250, as well as the independent micro-operations.

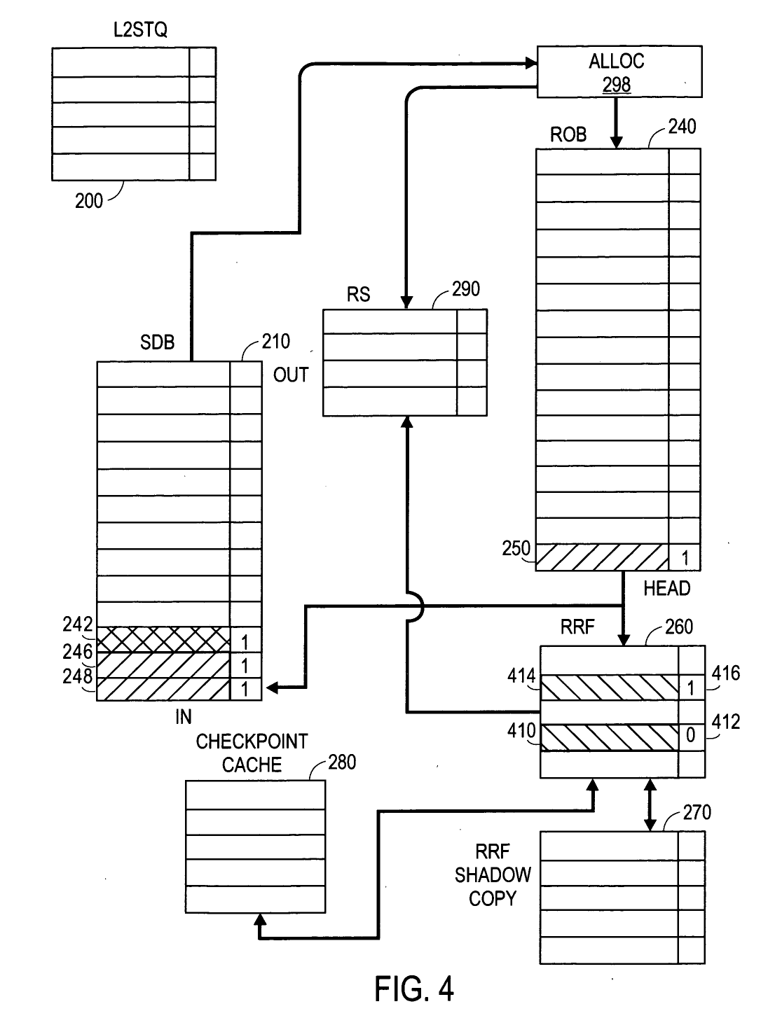

Referring now to FIG. 4, a schematic diagram of logic within a processor shows a dependent micro-operation being moved to a slice data buffer, according to one embodiment. In one embodiment, the dependent micro-operations 246, 248, each marked with a set poison bit, may in turn be loaded into SDB 210 when each reaches the head of ROB 240. Because SDB 210 is configured as a FIFO, the micro-operations travel to the outlet of SDB 210 in the order in which they were first inserted into SDB 210.

Entries in RRF 260 may continue to be changed as independent micro-operations execute and leave the ROB. In one example, an independent micro-operation, writing to its destination register, may overwrite an entry previously marked as poisoned with a new entry 410. Since this now contains valid data, the poisoned bit 412 may be cleared (e.g., contain value of logical true or “0”). But as more entries in ROB 240 are determined to be dependent upon the long-latency micro-operation, additional destination registers 414 may be marked as poisoned 416.

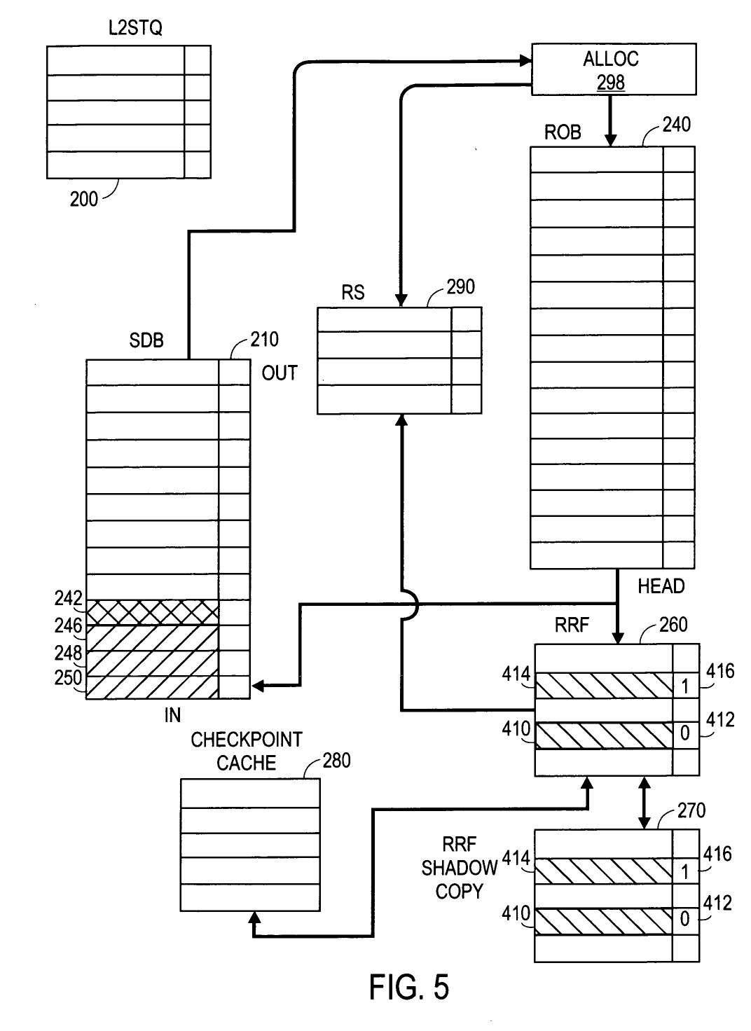

Referring now to FIG. 5, a schematic diagram of logic within a processor shows when a long-latency micro-operation is ready to execute, according to one embodiment. When the long-latency micro-operation is finally ready to execute, the contents of RRF 260, including the poisoned bits, may be copied into RRF shadow copy 270. The present contents of RRF 260 in RRF shadow copy 270 may be used to merge results after the micro-operations in SDB 210 are executed.

In FIG. 5, no more micro-operations may be found to be dependent upon the long-latency micro-operation 242. Therefore the micro-operations 242, 246, 248, and 250, together with their known source register values, are the only micro-operations that may need be reinserted into the ROB 240 for execution.

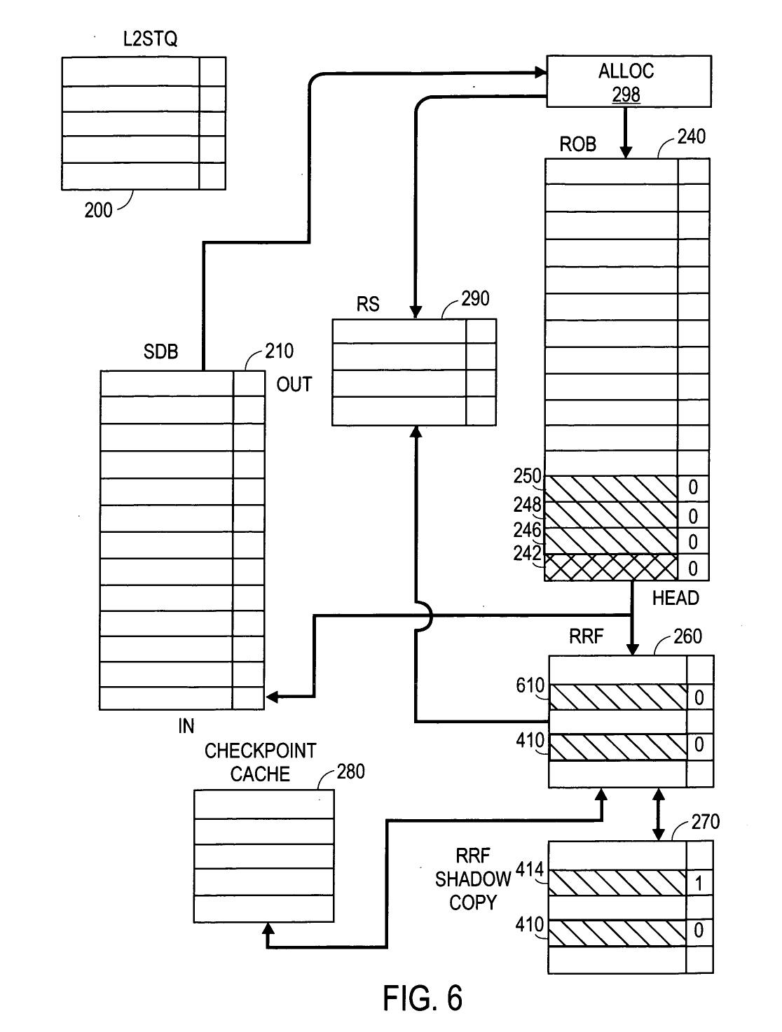

Referring now to FIG. 6, a schematic diagram of logic within a processor shows reinsertion of a long-latency micro-operation, according to one embodiment. Prior to re-insertion the front-end of the processor's pipeline may be stalled. Here the micro-operations 242, 246, 248, and 250, together with their known source register values, may pass through the ALLOC 298 stage. They may have their source and destination registers re-renamed and be reinserted into the ROB 240 for execution. Due to the pipeline's front-end being stalled, micro-operations 242, 246, 248, and 250, together with their known source register values, may pass through ROB 240 and long-latency micro-operation 242 may reach the head of ROB 240. It should be noted when micro-operations are re-inserted into ROB 240 that their corresponding poisoned bits are cleared.

Destination registers within RRF 260 may be updated by the execution of the long-latency micro-operation 242 or one of the dependent micro-operations 246, 248, 250. For example, in the FIG. 6 embodiment register value 610 overwrites the previous value. Since the re-inserted micro-operations have their poisoned bits cleared, the execution is valid and the corresponding poisoned bit 612 of register value 610 is clear.

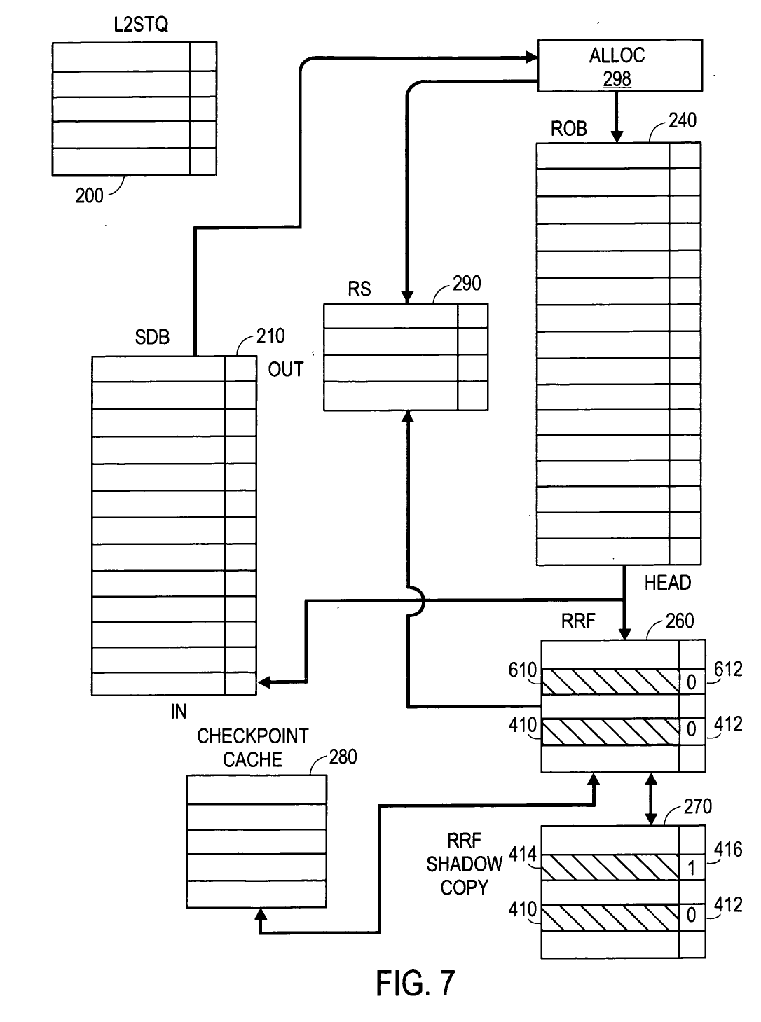

Referring now to FIG. 7, a schematic diagram of logic within a processor shows merging of register file copies, according to one embodiment. In this situation all of the long-latency micro-operation 242 and the dependent micro-operations 246, 248, 250 have executed and written their destination values to RRF 260, such as, for example, register value 610. The previously stored values in RRF shadow copy 270 may be copied over the values in RRF 260 in case their poisoned bits are zero. In this example, the copy of register value 410 in RRF shadow copy 270 (with poisoned bit 412 being cleared to zero) would be copied onto the corresponding location in RRF 260. However, the copy of register value 414 in RRF shadow copy 270 (with poisoned bit 416 being set to one) would not be copied onto the corresponding location in RRF 260. In this manner, by merging the appropriate values in RRF shadow copy 270 onto the RRF 260, the proper values of the registers are obtained after the execution of the micro-operations which passed through the SDB 210.

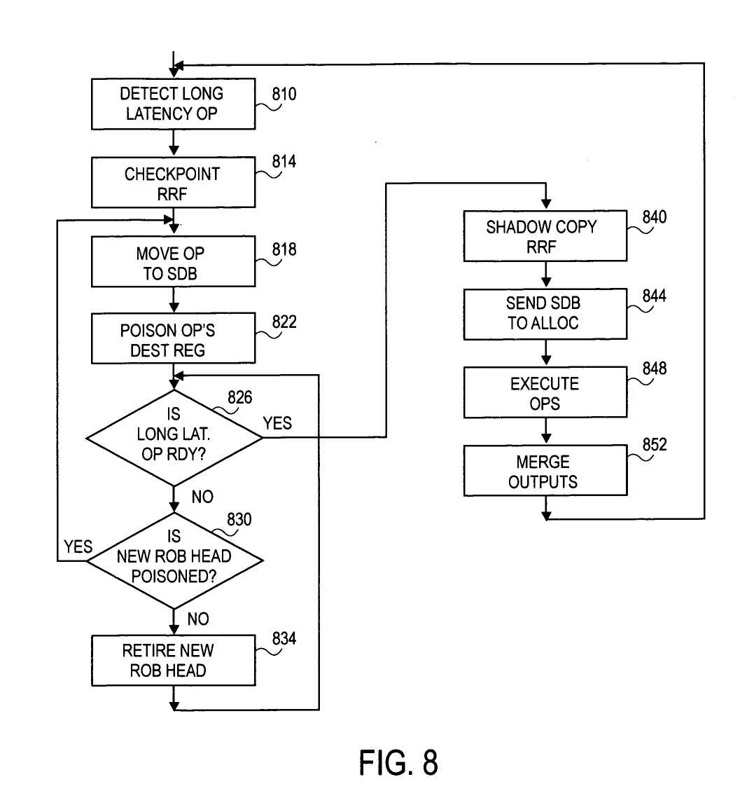

Referring now to FIG. 8, a flowchart diagram of a method for executing long-latency micro-operations is shown, according to one embodiment of the present disclosure. The method begins in block 810 when a long-latency micro-operation, such as a load that misses in the cache, is detected in the head position in a reorder buffer. Then in block 814 a checkpoint is saved of the present values in the real register file. In block 818 the long-latency micro-operation is removed from the head of the reorder buffer and placed into the slice data buffer. At or about the same time, in block 822 the micro-operation's destination register's poisoned bit is set. Also in block 822, it may be determined whether or not other micro-operations within the reorder buffer are dependent upon that micro-operation. This may take the form of determining whether the other micro-operations have a source register that is poisoned, and, if so, marking that micro-operation itself as poisoned in the reorder buffer.

In decision block 826, it may be determined whether or not the long-latency micro-operation is at last ready to execute. In one example, this may take the form of having the value from a load arrive in a buffer from system memory. If the answer is no, then the method exits via the NO path from decision block 826 and enters decision block 830.

In decision block 830 it may be determined whether or not the micro-operation presently in the head of the reorder buffer has a poisoned bit set. If the answer is yes, then the method exits via the YES path and returns to block 818, where the micro-operation presently at the head of the reorder buffer may be placed into the slice data buffer. If, however, the answer is no, then the method may exit via the NO path and in block 834 the micro-operation may be retired when it completes execution. The method then may return to decision block 826 to determine whether the long-latency micro-operation is ready to execute.

When, in decision block 826, it is determined that the long-latency micro-operation is at last ready to execute, then the method may exit via the YES path from decision block 826 and then may enter block 840. In block 840, after stalling the pipeline, the contents of the real register file may be copied into a real register file shadow copy. Then in block 844 the micro-operations with their available source register contents may be sent from the slice data buffer for allocation and register renaming. After this allocation and register renaming these micro-operations may be reinserted into the reorder buffer.

In block 848 the micro-operations may be executed from their location in the reorder buffer. As each in turn reaches the head of the reorder buffer, they may write their destination registers into the real register file and then retire. Finally, in block 852 the contents of the real register file shadow copy may be merged onto the real register file, where those entries in the real register file shadow copy may be overwritten into the real register file when the entries have a cleared (equal to zero) poisoned bit. After this the method returns to block 810 to await another long-latency micro-operation.

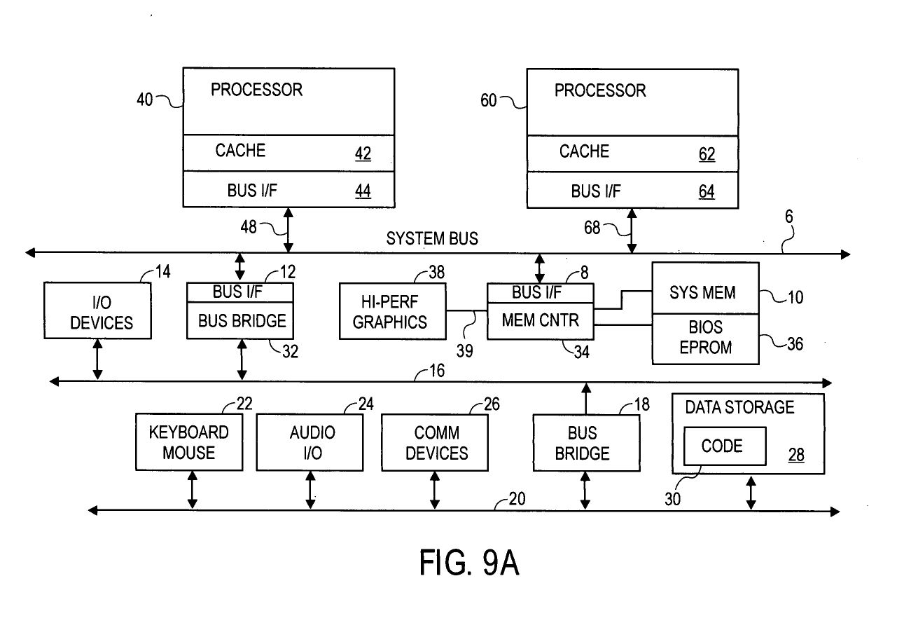

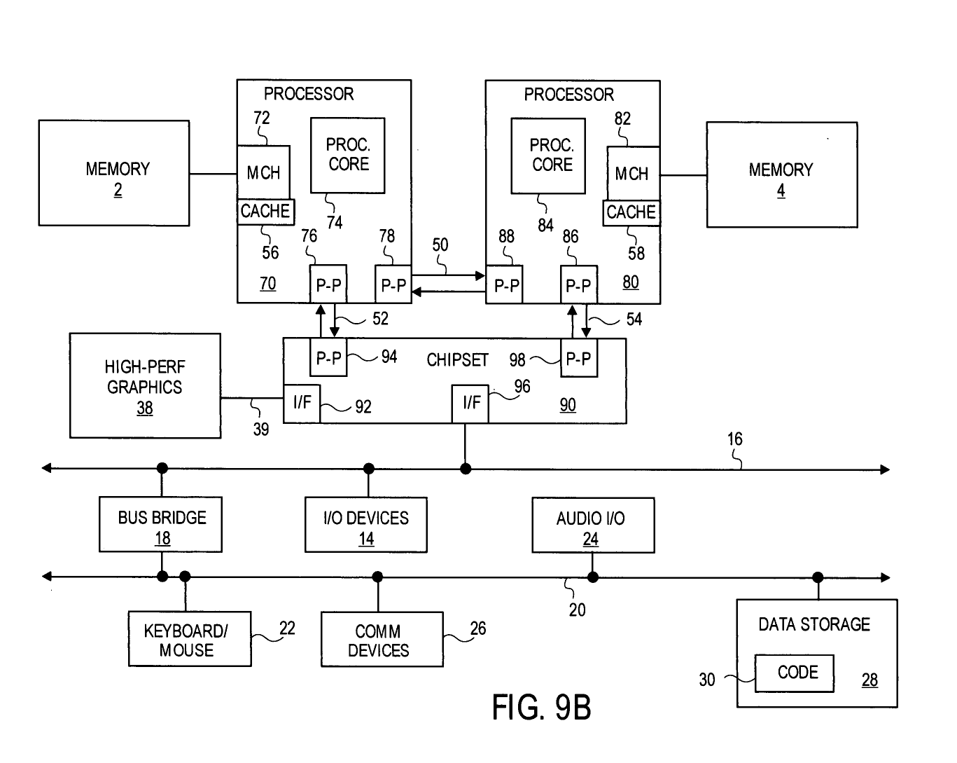

Referring now to FIGS. 9A and 9B, schematic diagrams of systems including processors whose pipelines include reorder buffers and slice data buffers are shown, according to two embodiments of the present disclosure. The FIG. 9A system generally shows a system where processors, memory, and input/output devices are interconnected by a system bus, whereas the FIG. 9B system generally shows a system where processors, memory, and input/output devices are interconnected by a number of point-to-point interfaces.

The FIG. 9A system may include several processors, of which only two, processors 40, 60 are shown for clarity. Processors 40, 60 may include last-level caches 42, 62. The FIG. 9A system may have several functions connected via bus interfaces 44, 64, 12, 8 with a system bus 6. In one embodiment, system bus 6 may be the front side bus (FSB) utilized with Pentium® class microprocessors manufactured by Intel® Corporation. In other embodiments, other busses may be used. In some embodiments memory controller 34 and bus bridge 32 may collectively be referred to as a chipset. In some embodiments, functions of a chipset may be divided among physical chips differently than as shown in the FIG. 9A embodiment.

Memory controller 34 may permit processors 40, 60 to read and write from system memory 10 and from a basic input/output system (BIOS) erasable programmable read-only memory (EPROM) 36. In some embodiments BIOS EPROM 36 may utilize flash memory. Memory controller 34 may include a bus interface 8 to permit memory read and write data to be carried to and from bus agents on system bus 6. Memory controller 34 may also connect with a high-performance graphics circuit 38 across a high-performance graphics interface 39. In certain embodiments the high-performance graphics interface 39 may be an advanced graphics port AGP interface. Memory controller 34 may direct data from system memory 10 to the high-performance graphics circuit 38 across high-performance graphics interface 39.

The FIG. 9B system may also include several processors, of which only two, processors 70, 80 are shown for clarity. Processors 70, 80 may each include a local memory controller hub (MCH) 72, 82 to connect with memory 2, 4. Processors 70, 80 may also include last-level caches 56, 58. Processors 70, 80 may exchange data via a point-to-point interface 50 using point-to-point interface circuits 78, 88. Processors 70, 80 may each exchange data with a chipset 90 via individual point-to-point interfaces 52, 54 using point to point interface circuits 76, 94, 86, 98. Chipset 90 may also exchange data with a high-performance graphics circuit 38 via a high-performance graphics interface 92.

In the FIG. 9A system, bus bridge 32 may permit data exchanges between system bus 6 and bus 16, which may in some embodiments be a industry standard architecture (ISA) bus or a peripheral component interconnect (PCI) bus. In the FIG. 9B system, chipset 90 may exchange data with a bus 16 via a bus interface 96. In either system, there may be various input/output (I/O) devices 14 on the bus 16, including in some embodiments low performance graphics controllers, video controllers, and networking controllers. Another bus bridge 18 may in some embodiments be used to permit data exchanges between bus 16 and bus 20. Bus 20 may in some embodiments be a small computer system interface (SCSI) bus, an integrated drive electronics (IDE) bus, or a universal serial bus (USB) bus. Additional I/O devices may be connected with bus 20. These may include keyboard and cursor control devices 22, including mice, audio I/O 24, communications devices 26, including modems and network interfaces, and data storage devices 28. Software code 30 may be stored on data storage device 28. In some embodiments, data storage device 28 may be a fixed magnetic disk, a floppy disk drive, an optical disk drive, a magneto-optical disk drive, a magnetic tape, or non-volatile memory including flash memory.

In the foregoing specification, the invention has been described with reference to specific embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A processor, comprising:
a first buffer to hold micro-operations and to permit execution of said micro-operations out-of-order; and
a second buffer to receive a first micro-operation of said micro-operations from said first buffer when said first micro-operation is determined to have long latency, to receive a first source operand of said first micro-operation, and to return said first micro-operation to said first buffer when said first micro-operation has completed execution.

2. The processor of claim 1, wherein said first buffer to mark entries of those of said micro-operations with a second source operand depending on said first micro-operation.

3. The processor of claim 2, wherein said first buffer may retire a second micro-operation whose entry is not marked.

4. The processor of claim 2, wherein said first buffer may move a third micro-operation whose entry is marked to said second buffer.

5. The processor of claim 2, further comprising a register file wherein a first register of said register file to indicate when said first register is a destination register of said first micro-operation.

6. The processor of claim 5, wherein contents of said first register are not used for retirement when said first register is a destination register.

7. The processor of claim 1, wherein said second buffer returns said first micro-operation to said first buffer via an allocation circuit.

8. A method, comprising:
identifying a first micro-operation in a reorder buffer as having a long latency;
moving said first micro-operation to a second buffer;
moving a first source operand of said first micro-operation to a third buffer; and
returning said first micro-operation to said reorder buffer after execution of said first micro-operation is complete.

9. The method of claim 8, further comprising identifying a second micro-operation as dependent upon output of said first micro-operation.

10. The method of claim 9, wherein said identifying includes marking entry of said second micro-operation in said reorder buffer as poisoned.

11. The method of claim 9, further comprising moving said second micro-operation into said second buffer.

12. The method of claim 8, further comprising marking an entry in a register file as poisoned when written by said first micro-operation.

13. The method of claim 12, further comprising making a shadow copy of said register file when a second source operand of said first micro-operation is ready.

14. The method of claim 13, further comprising merging said shadow copy with said register file when said first micro-operation is ready to retire.

15. The method of claim 14, wherein said merging includes using entries of said shadow copy without poison bits set.

16. A system, comprising:
a processor including a first buffer to hold micro-operations and to permit execution of said micro-operations out-of-order, and a second buffer to receive a first micro-operation of said micro-operations from said first buffer when said first micro-operation is determined to have long latency, to receive a first source operand of said first micro-operation, and to return said first micro-operation to said first buffer when said first micro-operation has completed execution;
a chipset;
a system interconnect to couple said cache to said chipset; and
an audio input/output to couple to said chipset.

17. The system of claim 16, wherein said first buffer to mark entries of those of said micro-operations with a second source operand depending on said first micro-operation.

18. The system of claim 17, wherein said first buffer may retire a second micro-operation whose entry is not marked.

19. The system of claim 17, wherein said first buffer may move a third micro-operation whose entry is marked to said second buffer.

20. The system of claim 17, further comprising a register file wherein a first register of said register file to indicate when said first register is a destination register of said first micro-operation.
